(19) United States
(12) Patent Application Publication
(10) Pub. No.: US 2009/0181297 A1
(43) Pub. Date: Jul. 16, 2009

(54) STORAGE CELL

(75) Inventors: Masashige Ashizaki, Osaka (JP); Masayuki Sato, Osaka (JP); Koichi Morikawa, Kyoto (JP); Nario Niibo, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/347,168

(22) Filed: Dec. 31, 2008

(30) Foreign Application Priority Data
Jan. 15, 2008 (JP) 2008-005353

(51) Int. Cl. H01M 2/26

(52) U.S. Cl. 429/161

(57) ABSTRACT

A storage cell includes a storage element, a first case having a first flat portion contacting an upper surface of the storage element and having a rectangular shape, a second case having a second flat portion contacting a lower surface of the storage element and having a rectangular shape, a gasket allowing the storage element to be accommodated between the first case and the second case, first and second terminal plates joined to the first and second cases, respectively, a first sealing resin for sealing the first case and the gasket, a second sealing resin for sealing the second case and the gasket, and a package resin covering the above components. The gasket has a rectangular frame shape, and has a cross section having substantially an H-shape. Edges of the first and second cases are inserted in recesses in the gasket and sealed with the first and second sealing resins, respectively. This storage cell has a high withstanding temperature and reduces an area having the cell mounted thereto.

### FIELD OF THE INVENTION

The present invention relates to a storage cell having substantively a rectangular cuboid shape.

### BACKGROUND OF THE INVENTION

FIG. 9A is a plan view of a conventional storage cell 40 disclosed in JP2002-170551A. FIG. 9B is a sectional view of storage cell 40 at line 9B-9B shown in FIG. 9A. Storage cell 40 includes storage element 49, such as a secondary battery or a capacitor, and has a coin shape to be surface-mounted. Storage element 49 includes positive polarizable electrode 41A, insulating separator 42, negative polarizable electrode 41B facing positive polarizable electrode 41A across separator 42, and an electrolyte solution impregnated in polarizable electrodes 41A and 41B and separator 42. Storage cell 40 further includes electrical collectors 43A and 43B provided on polarizable electrodes 41A and 41B, respectively, upper lid metal case 44 connected with collector 43A, lower lid metal case 45 connected with collector 43B, insulating gasket 46 coupling upper lid metal case 44 and lower lid metal case 45, positive electrode terminal plate 47 connected with upper lid metal case 44, and negative electrode terminal plate 48 connected with lower lid metal case 45. Upper lid metal case 44 and lower lid metal case 45 are sealed with gasket 46 by caulking or shrinking. Solder-plated portions 47A and 47B are provided at tips of terminal plates 47A and 48A, respectively.

As devices have had small sizes, electronic components including primary batteries and capacitors to be used as auxiliary power supplies or used for memory back-up are surface-mounted onto a circuit board. Storage cell 40 is surface-mounted onto a circuit board mainly by reflow soldering. Storage cell 40 is demanded to have a small size accordingly.

Upon being mounted onto the circuit board, storage cell 40 having the coin shape theoretically causes 22% of a square area having sides equal to the diameter of the coin shape. Terminal plates 47 and 48 of storage cell protrude from storage cell 40, thus further causing a loss of an area required to mount storage cell 40. Storage cell 40 having a diameter of 6 mm causes a loss of about 40% of the area.

A storage cell having a rectangular cuboid shape and including terminal plates within a contour of the storage cell reduce an area occupied by the storage cell smaller by 40% than that of storage cell 40.

In consideration of recent environmental issues, lead-free solder containing no lead is developed for reducing environmental burden. The melting point of the lead-free solder is higher than that of solder containing lead. Storage cell 40 is demanded to have a withstanding temperature to be mounted by reflow soldering.

When a storage cell having a rectangular cuboid shape is sealed by caulking or shrinking the upper lid metal case and the lower lid metal case via the gasket, the cell is not sealed uniformly particularly at corners of the rectangular cuboid shape. This may cause electrolyte solution to leak due to thermal stress caused by the reflow soldering upon being mounted onto the circuit.

If a storage cell having a rectangular cuboid shape is directly molded with resin without a metal case, the electrolyte solution may expand due to heat at the reflow soldering, and produce cracks in the resin, thus causing the electrolyte solution to leak.

### SUMMARY OF THE INVENTION

A storage cell includes a storage element, a first case having a first flat portion contacting an upper surface of the storage element and having a rectangular shape, a second case having a second flat portion contacting a lower surface of the storage element and having a rectangular shape, a gasket allowing the storage element to be accommodated between the first case and the second case, first and second terminal plates joined to the first and second cases, respectively, a first sealing resin for sealing the first case and the gasket, a second sealing resin for sealing the second case and the gasket, and a package resin covering the above components. The gasket has a rectangular frame shape, and has a cross section having substantially an H-shape. Edges of the first and second cases are inserted in recesses in the gasket and sealed with the first and second sealing resins, respectively.

This storage cell has a high withstanding temperature and reduces an area having the cell mounted thereto.

### BRIEF DESCRIPTION OF THE DRAWING

FIG. 1A is a plan view of a storage cell according to an exemplary embodiment of the present invention.

FIG. 1B is a sectional view of the storage cell at line 1B-1B shown in FIG. 1A.

FIG. 2A is a plan view of a metal case of the storage cell according to the embodiment.

FIG. 2B is a sectional view of the metal case at line 2B-2B shown in FIG. 2A.

FIG. 2C is an enlarged sectional view of the metal case shown in FIG. 2B.

FIG. 3A is a plan view of a gasket of the storage cell according to the embodiment.

FIG. 3B is a sectional view of the gasket at line 3B-3B shown in FIG. 3A.

FIG. 3C is an enlarged sectional view of the gasket shown in FIG. 3B.

FIG. 4 is a sectional view of another storage cell according to the embodiment.

FIG. 5 is a sectional view of still another storage cell according to the embodiment.

FIG. 6 is a sectional view of a further storage cell according to the embodiment.

FIG. 7 is a sectional view of a further storage cell according to the embodiment.

FIG. 8 shows evaluation results of storage cells according to the embodiment.

FIG. 9A is a plan view of a conventional storage cell.

FIG. 9B is a sectional view of the storage cell at line 9B-9B shown in FIG. 9A.

### DETAILED DESCRIPTION OF THE PREFERRED EMBODIMENT

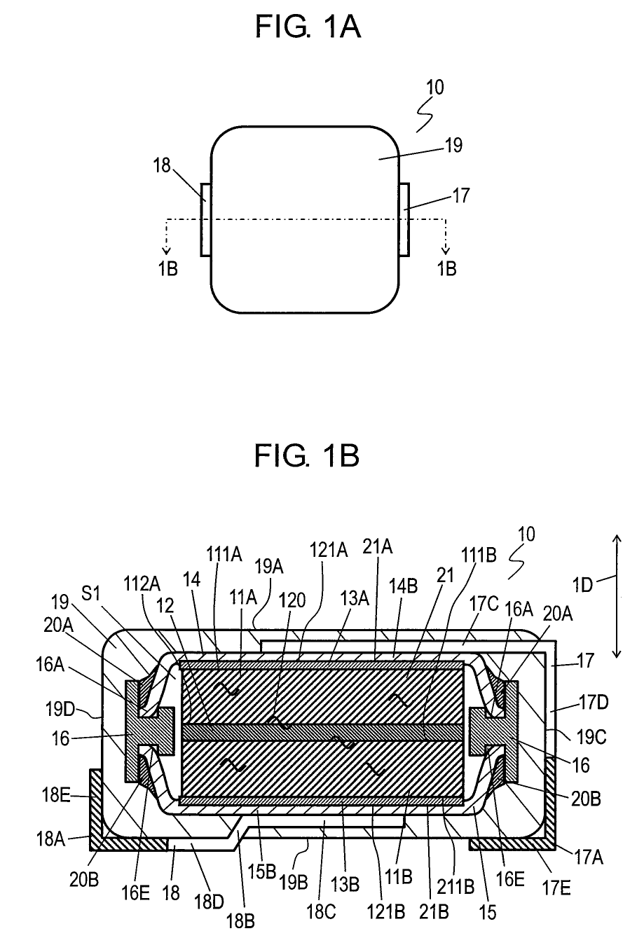

FIG. 1A is a plan view of a storage cell 10 according to an exemplary embodiment of the present invention. FIG. 1B is a sectional view of storage cell 10 at line 1B-1B shown in FIG. 1A. Storage cell 10 includes storage element 21 for storing electricity. Storage cell 10 is a storage cell adapted to be surface-mounted.

Storage element 21 adapted to store electricity has upper surface 121A and lower surface 121B opposite to each other along direction D1. Storage element 21 has a rectangular cuboid shape. Thus, upper surface 121A and lower surface 121B has rectangular shapes. Storage element 21 has positive electrode surface 21A provided on upper surface 121A and negative electrode surface 21B provided on lower surface 121B. Storage element 21 includes polarizable electrode 11B having a rectangular cuboid shape, separator 12 provided on upper surface 111B of polarizable electrode 11B, polarizable electrode 11A provided on upper surface 112A of separator 12, collector 13A provided on upper surface 111A of polarizable electrode 11A, collector 13B provided on lower surface 211B of polarizable electrode 11B, and electrolyte solution 120 impregnated in polarizing electrodes 11A and 11B and separator 12. Thus, Storage element 21 has a solution, electrolytic solution 21C, impregnated therein. Separator 12 has an insulating property. Polarizable electrodes 11A and 11B face each other across separator 12. Collectors 13A and 13B are made of conductive material, such as carbon. Collector 13A is located on upper surface 121A of storage element 21 and functions as electrode surface 21A. Collector 13B is located on lower surface 121B of storage element 21 and functions as electrode surface 21B. However, the shapes of upper surface 121A and lower surface 121B are not limited to the rectangular shapes. Thus, so far as storage element 21 has upper surface 121A and lower surface 121B opposite to each other along direction D1, storage element 21 may not necessarily have the rectangular cuboid shape.

Storage cell 10 further includes metal case 14 contacting electrode surface 21A of upper surface 121A of storage element 21, metal case 15 contacting electrode surface 21B of lower surface 121B of storage element 21, gasket 16 that couples metal cases 14 and 15, terminal plate 17 joined to upper surface 114A of metal case 14, terminal plate 18 joined to lower surface 115B of metal case 15, and package resin 19 covering storage element 21, metal cases 14 and 15, gasket 16, and terminal plates 17 and 18. Metal cases 14 and 15 are made of metal. Package resin 19 covers storage element 21, metal cases 14 and 15, gasket 16, and terminal plates 17 and 18 while portions of terminal plates 17 and 18 are exposed outside the resin.

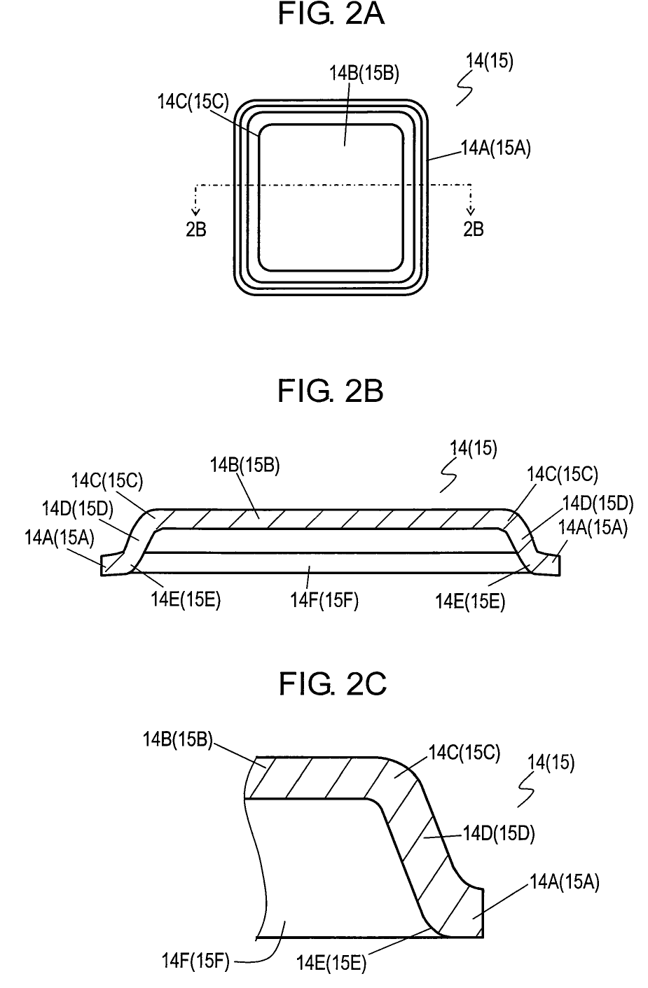

FIG. 2A is a plan view of metal cases 14 and 15. FIG. 2B is a sectional view of metal cases 14 and 15 at line 2B-2B shown in FIG. 2A. FIG. 2C is an enlarged sectional view of metal cases 14 and 15 shown in FIG. 2B. As shown in FIGS. 1A, 1B, and 2A, metal case 14 has opening 14F opening downward. Metal case 14 has flat portion 14B having substantially a rectangular shape, side wall 14D extending downward entirely from outer periphery 14C of flat portion 14B, and flange 14A that outwardly protrudes entirely from edge 14E of opening 14F, i.e., entirely from the lower end of side wall 14D. Metal case 15 has opening 15F opening upward. Metal case 15 flat portion 15B having substantively a rectangular shape, side wall 15D extending upward entirely from periphery 15C of flat portion 15B, and flange 15A that outwardly protrudes entirely from edge 15E of opening 15F, i.e., entirely from a lower end of side wall 15. As shown in FIG. 1B, flat portions 14B and 15B of metal cases 14 and 15 contact and are connected with electrode surfaces 21A and 21B of storage element 21, respectively, and are perpendicular to direction D1. Flanges 14A and 15A extend perpendicularly to direction D1.

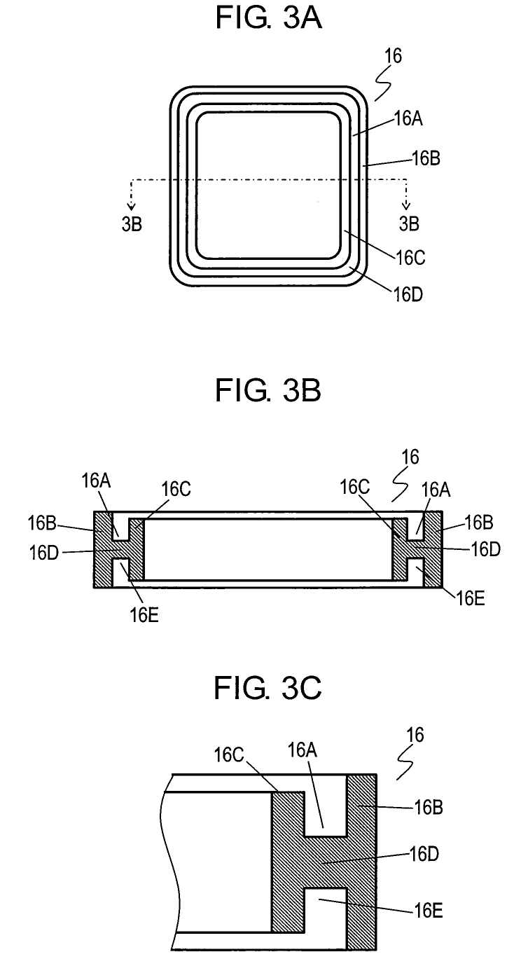

FIG. 3A is a plan view of gasket 16. FIG. 3B is a sectional view of gasket 16 at line 3B-3B shown in FIG. 3A. FIG. 3C is an enlarged sectional view of gasket 16 shown in FIG. 3B. Gasket 16 is made of thermoplastic resin and has a rectangular frame shape. The cross-section of gasket 16 has substantively an H-shape having outer wall 16B extending in direction D1, inner wall 16C located inward outer peripheral wall 16B and extending in direction D1, and bridge portion 16D coupling a middle point of outer wall 16B and a middle point of inner wall 16C. Recess 16A is provided above bridge portion 16D and surrounded by outer wall 16B, inner wall 16C, and bridge portion 16D. Recess 16E is provided below bridge portion 16D and surrounded by outer wall 16B, inner wall 16C, and bridge portion 16D. Flange 14A provided at edge 14E of opening 14F of metal case 14 is inserted and held in recess 16A of insulating gasket 16. Similarly, flange 15A provided at edge 15E of opening 15F of metal case 15 is inserted and held in recess 16E of insulating gasket 16. This structure provides hermetic space S1 surrounded by metal cases 14 and 15 and gasket 16 (FIG. 1B). Storage element 21 is accommodated in hermetic space S1.

Side wall 14D of metal case 14 faces outer peripheral wall 16B of gasket 16. All of the space surrounded by side wall 14D and flange 14A of metal case 14 and outer wall 16B of gasket 16 are filled with sealing resin 20A for bonding and sealing metal case 14 and gasket 16. Similarly, side wall 15D of metal case 15 faces outer wall 16B of gasket 16. All of the space surrounded by side wall 15D and flange 15A of metal case 15 and outer wall 16B of gasket 16 are filled with sealing resin 20B for bonding and sealing metal case 15 and gasket 16. Sealing resins 20A and 20B have resilience.

Joining portions 17C and 18C of terminal plates 17 and 18 having plate shapes are joined by laser welding to flat portions 14B and 15B of metal cases 14 and 15, respectively. Terminal plate 18 has step portion 18B extending from joining portion 18C depart from metal case 15, joining portion 18D extending from step portion 18B in parallel to joining portion 18C, namely, in parallel to flat portion 15B of metal case 15, and extension portion 18E extending upward from joining portion 18D. Terminal plate 17 has joining portion 17D extending downward from joining portion 17C and extension portion 17E extending from joining portion 17D in parallel to joining portion 18C, namely, in parallel to flat portion 15B of metal case 15. Storage element 21, metal cases 14 and 15, gasket 16, and terminal plates 17 and 18 are covered with package resin 19 having an insulating property while exposing joining portion 17D and extension portion 17E of terminal plate 17 and joining portion 18D and extension portion 18E of terminal plate 18. Package resin 19 has upper surface 19A parallel to flat portion 14B of metal case 14, lower surface 19B parallel to flat portion 15B of metal case 15, side surface 19C connecting to upper surface 19A and lower surface 19B, and side surface 19D opposite to side surface 19C. Side surfaces 19C and 19D face gasket 16 and side walls 14D and 15D of metal cases 14 and 15 across package resin 19. Upper surface 19A, lower surface 19B, and side surfaces 19C and 19D have substantively rectangular shapes, and thus, package resin 19 has substantively a rectangular cuboid shape. Joining portion 17D and extension portion 17E of terminal plate 17 extend along side surface 19C and lower surface 19B, respectively. Joining portion 18D and extension portion 18E of terminal plate 18 extend along lower surface 19B and side surface 19D, respectively.

Plated portion 17A formed by plating is provided on joining portion 17D and extension portion 17E of terminal plate 17. Plated portion 18A formed by plating is provided on joining portion 18D and extension portion 18E of terminal plate 18.

Sealing resins 20A and 20B are made of silicone resin, thermosetting resin. Sealing resins 20A and 20B may be made of other thermosetting resin, such as fluorine-based resin or epoxy-based resin.

Terminal plates 17 and 18 may be joined with metal cases 14 and 15 by mechanical caulking, ultrasonic welding, or spot resistance welding.

A method of manufacturing polarizable electrodes 11A and 11B will be described below. Activated carbon powder, conductive agent, and binder are mixed and kneaded with a kneading machine, thereby providing material paste. This material paste is molded to have a rectangular cuboid shape having a predetermined size and is dried, thereby providing polarizable electrodes 11A and 11B. According to the embodiment, the conductive agent employs carbon black, and the binder employs polytetrafluoroethylene.

Metal cases 14 and 15 are formed by pressing stainless steel plates to have the same shapes and dimensions.

Insulating gasket 16 is made of thermoplastic resin. According to the embodiment, gasket 16 is made of polyphenylene sulfide (PPS).

Package resin 19 is made of thermosetting resin, such as epoxy resin. Metal cases 14 and 15 and portions terminal plates 17 and 18 installed in an injection molding die are molded with the resin while metal cases 14 and 15 and the portions terminal plates 17 and 18 are supported with sliding pins, thereby providing package resin 19. Package resin 19 may not necessarily be made of the thermosetting resin, and may be made of thermoplastic resin.

If package resin 19 is molded at a temperature higher than a withstanding temperature of sealing resins 20A and 20B, sealing resins 20A and 20B deteriorate due to heat particularly in sealing performance. Sealing resins 20A and 20B have withstanding temperatures higher than a molding temperature at which package resin 19 is molded. This arrangement prevents sealing resins 20A and 20B from deteriorating in sealing performance of sealing resins 20A, 20B, thus assuring reliability.

Sealing resins 20A and 20B are made of sealing resin, such as fluorine-based resin, silicone resin, or epoxy resin. In the case that sealing resins 20A and 20B are made of fluorine-based resin or silicone resin, sealing resins 20A and 20B have superior heat resistance and cold resistance, and adhere tightly to metal cases 14 and 15 and gasket 16 made of thermoplastic resin, accordingly providing high sealing performance. Sealing resins 20A and 20B may be formed by applying and hardening liquid of the thermosetting resin between metal case 14 and outer wall 16B and between metal case 15 and outer wall 16B.

Package resins 19 is made of epoxy resin, thermosetting resin, and is molded at a temperature ranging approximately from 150° C. to 200° C. In the case that sealing resins 20A and 20B are made of thermosetting resin, sealing resins 20A and 20B may be made preferably of fluorine-based resin or silicone resin both having a withstanding temperature higher than 220° C. In the case that sealing resins 20A and 20B are made of thermoplastic resin, sealing resins 20A and 20B may be made preferably of polyphenylene sulfide (PPS) or glass-filled PPS both having a withstanding temperature higher than 260° C. or liquid crystal polymer (LCP) having a withstanding temperature higher than 270° C., or polyetheretherketone (PEEK) having a withstanding temperature higher than 300° C.

Each of fluorine-based resin and silicone resin forming sealing resins 20A and 20B has superior cold resistance and heat resistance, is resilience even at low temperatures, is are stable even at high temperatures. Sealing resins 20A and 20B allows flanges 14A and 15A of metal cases 14 and 15 to adhere to gasket 16 in recesses 16A and 16E of gasket 16 and maintain sealing performance against heat shock, thus providing storage cell 10 with high weather-resistance and reliability.

In the case that sealing resins 20A and 20B are made of fluorine-based resin, the fluorine-based resin has superior low-temperature resistance and lower moisture permeability than other resins and rubber, and accordingly allows sealing resins 20A and 20B to prevent water and gas from entering into storage element 21, thus providing high sealing performance.

Sealing resins 20A and 20B are made preferably of either fluorine-based resin or silicone resin. SIFEL™, fluorine-based elastomer manufactured by Shin-Etsu Chemical Co., Ltd., may be employed as the fluorine-based resin. Sealing resins 20A and 20B are formed by applying this elastomer on recesses 16A and 16E of gasket 16 and subsequently heating the applied elastomer at a temperature of 150° C. Sealing resins 20A and 20B may be made of CHEMISEAL™, silicone resin manufactured by Chemitech Inc.

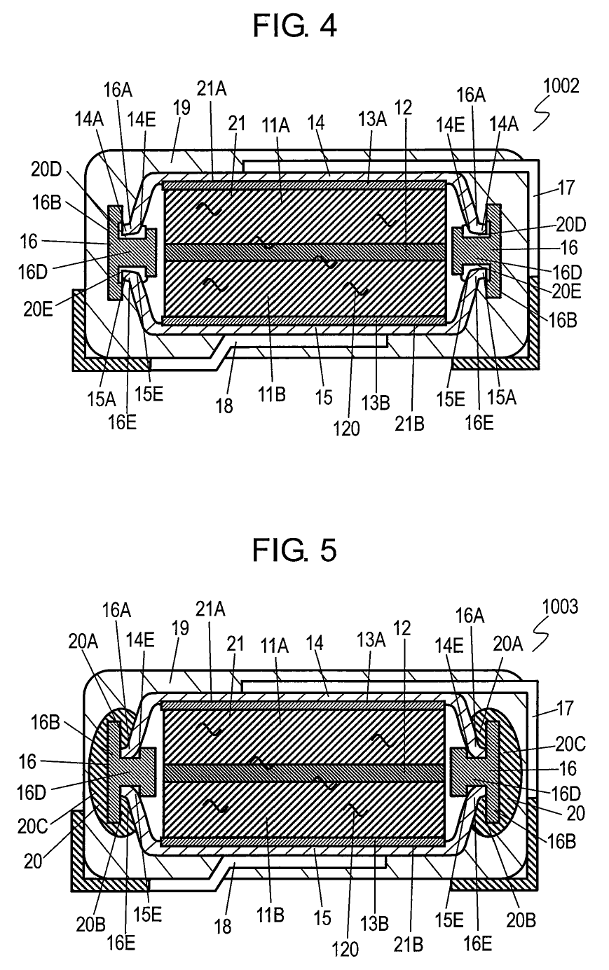

FIG. 4 is a sectional view of another storage cell 1002 in accordance with the embodiment. In FIG. 4, components identical to those of storage cell 10 shown in FIG. 1B are denoted by the same reference numerals, and their description will be omitted. Storage cell 1002 shown in FIG. 4 includes sealing resins 20D and 20E instead of sealing resins 20A and 20B of storage cell 10 shown in FIG. 1B. In storage cell 1002 shown in FIG. 4, after sealing resins 20D and 20E are previously applied on recesses 16A and 16E of gasket 16, respectively, flanges 14A and 15A of metal cases 14 and 15 are inserted into recesses 16A and 16E of gasket 16, respectively. Then, metal cases 14 and 15 are pressed to approaching each other so as to press flanges 14A and 15A of metal cases 14 and 15 to sealing resins 20D and 20E, respectively. This process allows sealing resins 20D and 20E to have uniform thicknesses and resilience and to tightly seal between flanges 14A and 15A of metal cases 14 and 15 and outer wall 16B of gasket 16, between flanges 14A and 15A and inner wall 16C, and between flanges 14A and 15A and bridge portion 16D of gasket 16, thus tightly sealing metal cases 14 and 15 and gasket 16. Upon being pressed, flanges 14A and 15A of metal cases 14 and 15 cause sealing resins 20D and 20E to deform. Then, sealing resins 20D and 20E are hardened. Sealing resins 20D and 20E maintain resilience even after the hardening of resins 20D and 20E.

Each of fluorine-based resin and silicone resin, materials of sealing resins 20D and 20E, is superior in cold resistance and heat resistance, accordingly maintaining resilience at low temperatures and being stable at high temperatures. Sealing resins 20D and 20E allow flanges 14A and 15A of metal cases 14 and 15 to adhere to gasket 16 in recesses 16A and 16F of gasket 16. Sealing resins 20D and 20E is superior in sealing performance even when receiving thermal shock, thus providing storage cell 1002 with high weather-resistance and reliability.

In the case that sealing resins 20D and 20E are made of fluorine-based resin, sealing resins 20D and 20E have superior cold resistance and lower moisture permeability than other resins and rubber, and accordingly prevent gas and water from entering into storage cell 21, thus having high sealing performance.

Sealing resins 20D and 20E are made preferably of either fluorine-based resin or silicone resin. SIFEL™, fluorine-based elastomer manufactured by Shin-Etsu Chemical Co., Ltd., may be employed as the fluorine-based resin. Sealing resins 20D and 20E are formed by applying this elastomer on recesses 16A and 16E of gasket 16 and subsequently heating the applied elastomer at a temperature of 150° C. Sealing resins 20A and 20B may be made of CHEMISEAL™, silicone resin manufactured by Chemitech Inc.

FIG. 5 is a sectional view of still another storage cell 1003 according to the embodiment. In FIG. 5, components identical to those of storage cell 10 shown in FIG. 1B are denoted by the same reference numerals, and their description will be omitted. Storage cell 1003 shown in FIG. 5 further includes sealing resin 20C connected with sealing resins 20A and 20B of storage cell 10 shown in FIG. 1B along outer wall 16B of gasket 16. Sealing resin 20C is made of the same material as sealing resins 20A and 20B. That is, sealing resins 20A to 20C are unitarily formed to provide sealing resin 20 for sealing flanges 14A and 15A of metal cases 14 and 15 and recesses 16A and 16F of gasket 16. Sealing resin 20 covers the entire surface of outer wall 16B of gasket 16. That is, sealing resin 20 entirely covers outer wall 16B of gasket 16. This structure seals flanges 14A and 15A of metal cases 14 and 15 and gasket 16 tightly without influence by airtightness at the border between outer wall 16B of gasket 16 and sealing resin 20.

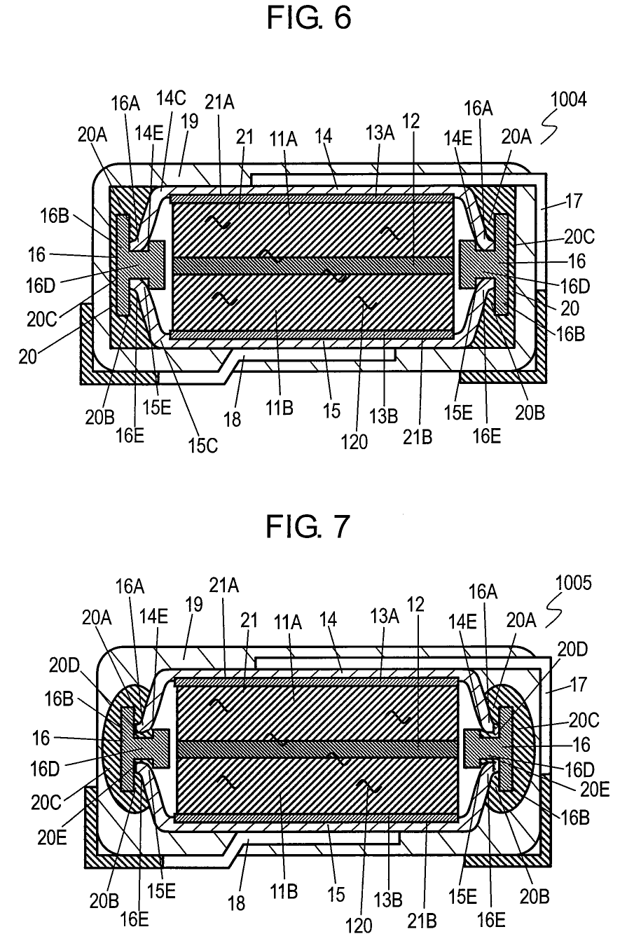

FIG. 6 is a sectional view of further storage cell 1004 in accordance with the embodiment. In FIG. 6, components identical to those of storage cell 1003 shown in FIG. 5 are denoted by the same reference numerals, and their description will be omitted. In storage cell 1004 shown in FIG. 6, sealing resin 20 extends to outer periphery 14C and 15C of metal cases 14 and 15, and entirely covers side walls 14D and 15D of cases 14 and 15. This structure seals flanges 14A and 15A of metal cases 14 and 15 and gasket 16 tightly without influence by airtightness at the border between outer wall 16B of gasket 16 and sealing resin 20.

FIG. 7 is a sectional view of further storage cell 1005 in accordance with the embodiment. In FIG. 7, components identical to those of storage cell 1003 shown in FIG. 5 are denoted by the same reference numerals, and their description will be omitted. In storage cell 1005 shown in FIG. 7, similarly to storage element 1002 shown in FIG. 4, after sealing resins 20D and 20E are previously applied in recesses 16A and 16E of gasket 16, flanges 14A and 15A of metal cases 14 and 15 are inserted in recesses 16A and 16E of gasket 16, respectively. Then, metal cases 14 and 15 are pressed to approach each other so as to press flanges 14A and 15A of metal cases 14 and 15 to sealing resins 20D and 20E, respectively. This process allows sealing resins 20D and 20E to have uniform thicknesses and resilience and to tightly seal between flanges 14A and 15A of metal cases 14 and 15 and outer wall 16B of gasket 16, between flanges 14A and 15A and inner wall 16C of gasket 16, and between flanges 14A and 15A and bridge portion 16D of gasket 16. Upon being pressed, flanges 14A and 15A of metal cases 14 and 15 cause sealing resin 20 to deform. Then, sealing resins 20A, 20B, and 20C are applied. Sealing resins 20A to 20E are made of the same material. This structure seals tightly between flanges 14 and 15A of metal cases 14 and 15 and gasket 16 without influence by airtightness at the border between outer wall 16B of gasket 16 and sealing resin 20.

Each of storage cells 10 and 1002 to 1005 in accordance with the embodiment has a double sealing structure including sealing resins 20, and 20A to 20E and package resin 19 for sealing edges 14E and 15E of metal cases 14 and 15. This structure provides storage cells 10 and 1002 to 1005 with high heat resistance and small sizes.

Storage cells 10 and 1002 to 1005 in accordance with the embodiment include sealing resins 20 and 20A to 20E tightly sealing metal cases 14 and 15 and gasket 16, and have heat resistance to withstand a high temperature due to reflow soldering with lead-free solder, while having rectangular cuboid shapes reducing loss of mounting area.

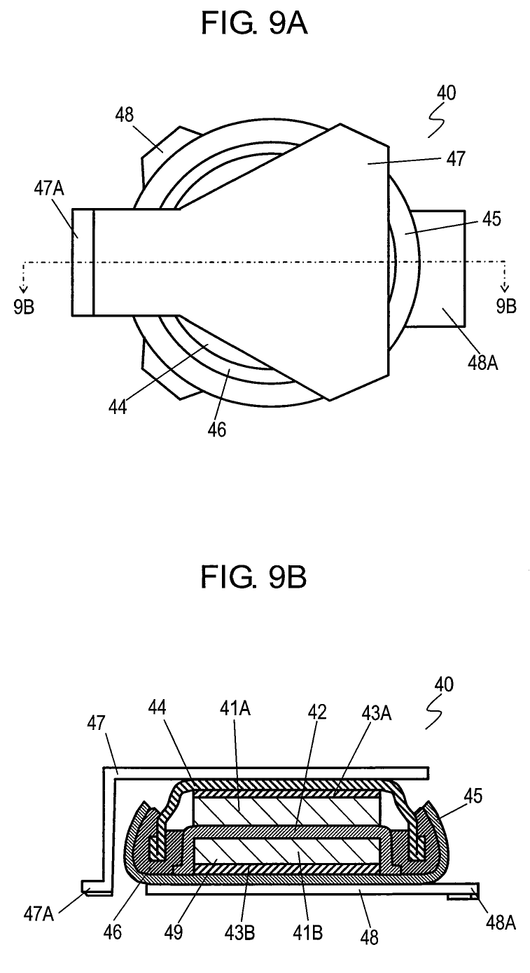

Fifty samples of each of examples 1 to 3 of storage cells in accordance with the embodiment and a comparative example of conventional storage cells 40 shown in FIG. 9A and FIG. 9B were prepared.

Epoxy resin was applied onto gasket 16 made of glass-filled PPS to form sealing resins 20A and 20B, thereby preparing example 1 of storage cell 10 shown in FIG. 1B Liquid fluorine-based resin was applied onto gasket 16 to form sealing resins 20A and 20B, thereby example 2 of storage cell 1002 shown in FIG. 4.

Liquid fluorine-based resin was applied onto gasket 16 to form sealing resin 20, and then, package resin 19 was formed by injection-molding polyphenylene sulfide (PPS), thermoplastic resin, thereby preparing example 3 of storage cell 1004 shown in FIG. 6.

Square stainless steel cases were sealed by caulking thereby preparing the comparative example of the conventional storage cell.

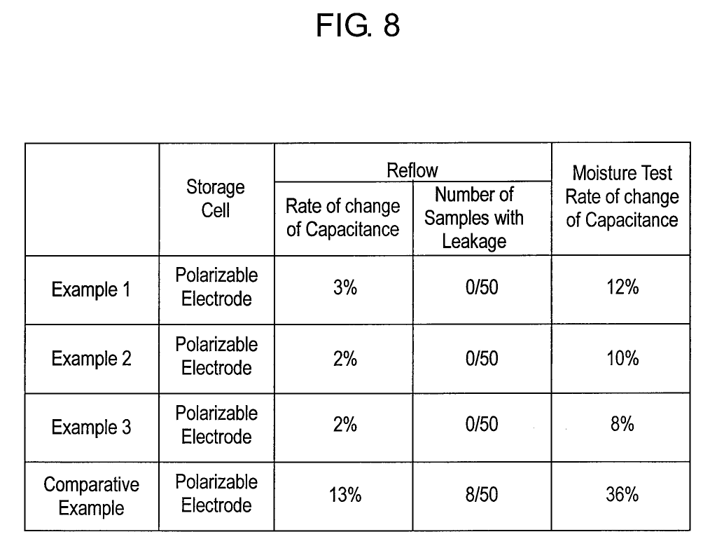

Samples of examples 1 to 3 and the comparative example were surface-mounted on a printed circuit board by reflow soldering with lead-free solder at a peak temperature of 260° C. for 40 seconds. FIG. 8 shows the rate of the change of each of capacitances of these samples before and after the mounting, and the number of samples having the electrolyte solution leak. Moisture resistant load test was also conducted on these samples. In the moisture resistant load test, a voltage of 2.6V was applied for 1,000 hours at a temperature of 40° C. under a humidity of 60% RH. FIG. 8 also shows the rate of change of each of the capacitances of these samples before and after the moisture resistance load test.

As shown in FIG. 8, each of examples 1 to 3 exhibited the rate of the capacitance change due to reflow smaller than that of eth comparative example, and exhibited no electrolyte solution leakage. Thus, Example 1 to 3 withstand high reflow temperature for lead-free solder. Further, in eth moisture resistant load test, the rate of eth capacitance change of examples 1 to 3 were smaller than that of the comparative example, thus providing the storage cells with high reliability.

Storage element 21 of storage cell 10 is an electric double layer capacitor, but it is not limited to this. Storage element 21 of storage cell 10 in accordance with the embodiment may be other storage element, such as a secondary battery, having electrode surfaces 21A and 21B provided on upper surface 121A and lower surface 121B, thus providing the same effects.

According to the embodiment, terms, such as “upper surface,” “lower surface,” “above,” and “below”, indicating directions merely indicate relative directions depending on positions of structural components, such as storage element 21 and metal cases 14 and 15, of the storage cell, and do not indicate absolute directions, such as a vertical direction.

What is claimed is:

1. A storage cell comprising:
a storage element having an upper surface and a lower surface, the upper surface having a first electrode surface, the lower surface having a second electrode surface;
a first case having a first flat portion and a first side wall extending downward entirely from an outer periphery of the first flat portion, the first flat portion contacting the first electrode surface of the storage element and having a rectangular shape, the first case having an opening which opens downward, the first case having a first edge of the opening;
a second case having a second flat portion and a second side wall extending upward entirely from an outer periphery of the second flat portion, the second flat portion contacting the second electrode surface of the storage element and having a rectangular shape, the second case having an opening which opens upward, the second case having a second edge of the opening;
a gasket provided between the first edge of the first case and the second edge of the second case, the gasket allowing the storage element to be accommodated between the first case and the second case, the gasket having a rectangular frame shape and having an insulating property;
a first terminal plate joined to the first case;
a second terminal plate joined to the second case;
a first sealing resin for sealing the first case and the gasket;
a second sealing resin for sealing the second case and the gasket; and
a package resin covering the first case, the second case, the gasket, the first sealing resin, the second sealing resin, the first terminal plate, and the second terminal plate, such that a portion of the first terminal plate and a portion of the second terminal plate are exposed from the package resin; wherein
the gasket has a cross section having substantially an H-shape having an outer wall, an inner wall provided inside the outer wall, and a bridge portion joining the outer wall and the inner wall, the H-shape providing a first recess and a second recess, the first recess being surrounded by the outer wall, the inner wall, and the bridge portion above the bridge portion, and the second recess being surrounded by the outer wall, the inner wall, and the bridge portion below the bridge portion,
the first edge of the first case is inserted in the first recess of the gasket and sealed with the first sealing resin, and
the second edge of the second case is inserted in the second recess of the gasket and sealed with the second sealing resin.

2. The storage cell of claim 1, wherein
the package resin is made of molded resin, and
the first sealing resin and the second sealing resin have withstanding temperatures higher than a molding temperature at which the resin of the package resin is molded.

3. The storage cell of claim 2, wherein the first sealing resin and the second sealing resin are made of fluorine-based resin, silicone resin, or epoxy resin.

4. The storage cell of claim 1, wherein
the first sealing resin has resilience and is provided between the bridge portion of the gasket and the first edge of the first case, and
the second sealing resin has resilience and is provided between the bridge portion of the gasket and the second edge of the second case.

5. The storage of claim 1, further comprising
a third sealing resin connected with the first sealing resin and the second sealing resin, the third resin entirely covering the outer wall of the gasket,
wherein the package resin covers the first case, the second case, the gasket, the first sealing resin, the second sealing resin, the third sealing resin, the first terminal plate, and the second terminal plate.

6. The storage cell of claim 1, wherein
the first case further has a first flange protruding outward from the first edge, and
the second case further has a second flange protruding outward from the second edge.

7. The storage cell of claim 1, wherein the storage element has a rectangular cuboid shape.

8. The storage cell of claim 1, wherein the first case and the second case are made of metal.
